(19) United States
(12) Patent Application Publication
(10) Pub. No.: US 2004/0019724 A1
(43) Pub. Date: Jan. 29, 2004

(54) Computer system with docking port for a handheld computing device

(76) Inventors: Charles W. Singleton, JR., Vancouver, WA (US); Michael Scott Carson, Monroe, OR (US)

Correspondence Address: HEWLETT-PACKARD COMPANY, Intellectual Property Administration, P.O. Box 272400, Fort Collins, CO, 80527-2400, US

(21) Appl. No.: 10/201,883

(22) Filed: Jul. 24, 2002

(51) Int. Cl. G06F 13/00

(52) U.S. Cl. 710/303

(57) ABSTRACT

A computing system is described. The computing system can include a handheld computing device that has one or more input mechanisms to allow user input. The system can also include a computer configured to dock with the handheld computing device. The computing system is configured to allow user input to the computer through manipulation of the one or more input mechanisms of the handheld computing device when the handheld computing device is docked with the computer.

### BACKGROUND

With the increased mobility of people in today's workforce, the demand for mobile computing and communication capabilities outside of the office has increased dramatically. Those inside the office, as well as those who typically work outside the office, often require the ability to communicate with others and other devices to access or transfer various data files. In response to this demand, handheld computing devices such as personal digital assistants (PDAs) have been developed.

A PDA is a compact device that can serve various functions including a cellular phone, facsimile transmitter, personal organizer, and the like. PDAs typically include a stylus and a touch-sensitive screen for user input, and may include a keyboard or a limited number of input keys. PDAs can be used for such things as sending and retrieving e-mail, Web browsing, and data-sharing applications over the Internet, intranet or corporate networks.

Often it is desired to dock a PDA with a base computer such as a desktop computer or a notebook computer. Docking can allow data to be shared between the two devices as well as recharging the PDA from the power supply of the computer. However, with existing technologies, the capabilities and features of the PDA are often under-utilized in the computing system. Therefore, it would be beneficial to improve the functionality of the PDA and the computer when viewed as a computing system.

Accordingly, the described embodiments provide improved computing systems with dockable components.

### BRIEF DESCRIPTION OF THE DRAWINGS

The same numbers are used throughout the drawings to reference like features and components.

FIG. 1 illustrates a personal digital assistant (PDA) separate from, but dockable with, a portable computer in accordance with one exemplary embodiment.

FIG. 2 illustrates a PDA docked with a portable computer in accordance with one exemplary embodiment.

FIG. 3 illustrates a personal digital assistant (PDA) separate from, but dockable with, a portable computer in accordance with one exemplary embodiment.

FIG. 4 is a block diagram of selected functional components of a PDA and a portable computer in accordance with one exemplary embodiment.

FIG. 5 is a flow chart showing steps in accordance with one exemplary method.

### DETAILED DESCRIPTION OVERVIEW

The described embodiments relate to a computing system and components thereof. The computing system can comprise a handheld computing device, such as a personal digital assistant (PDA). The PDA can have various input mechanisms such as buttons and a touch-sensitive screen. The PDA can be configured to be docked with a base computer, such as a notebook computer. The notebook computer can be configured with a docking port that can functionally dock with the PDA. When docked, some embodiments can allow a user to engage the notebook computer through manipulation of the PDA's input mechanisms or devices. For example, in one such embodiment, a PDA can be docked with a notebook computer. A user can then physically engage the touch-sensitive screen to select a desired icon on the notebook computer.

### EXEMPLARY EMBODIMENTS

An exemplary computing system includes a handheld computing device (e.g., a personal digital assistant (PDA), cellular phone, etc.) and a base computer capable of docking with the handheld computing device. When docked, the handheld computing device can, in some embodiments, be safely stored and ported with the base computer and can synchronize event data (e.g., calendar, appointments, etc.), email, and other information with the base computer. Further, in some embodiments, the base computer can be controlled by a user through manipulation of input mechanisms of the handheld computing device.

The computing system is described in the context of a base computer adapted to dock a handheld computing device. In the examples shown here, the handheld computing device can comprise a PDA. In particular, one type of PDA is illustrated for discussion purposes, although other types of PDAs may be used. PDAs are constructed in many different shapes and sizes, as well as with different functionality (e.g., personal organizer, browser, cellular phone, facsimile transmitter, etc.). Additionally, the computer may be configured to dock other types of handheld computing devices, such as pagers, cellular phones and/or other devices having similar functionalities or combinations of functionalities.

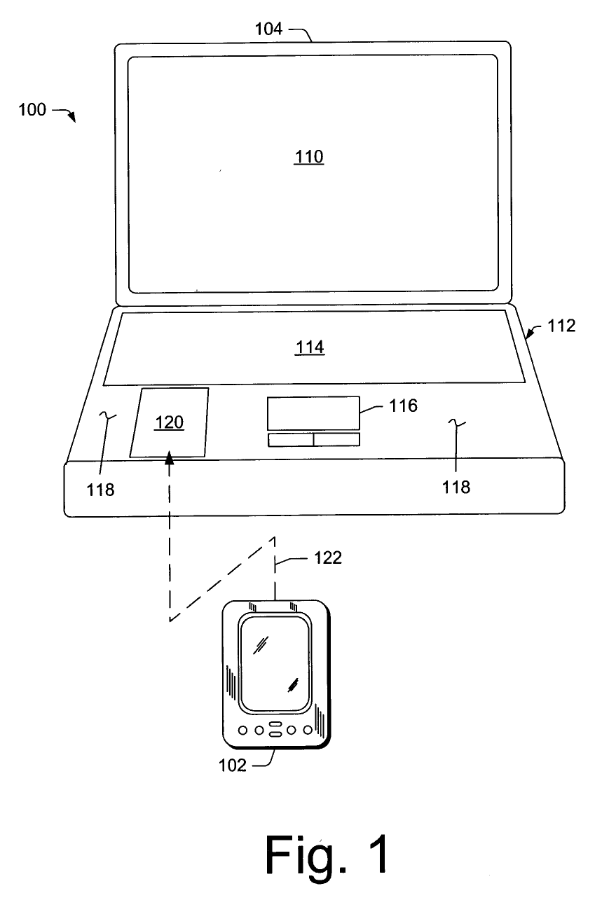

FIG. 1 illustrates an exemplary computing system 100 composed of a personal digital assistant (PDA) 102 and a portable computer 104 (e.g., laptop, notebook, etc.). In this embodiment, the portable computer 104 includes a display 110 mounted in a lid that is connected via a hinge to a body 112 to move between an open position (as shown) and a closed position where the display lid is folded onto the body 112. In various embodiments, the body 112 can house a keyboard 114 and a touch/track pad input mechanism 116. In some embodiments, the body 112 can also define a palm rest 118 juxtaposed with the keyboard 114 and straddling the mouse/touch pad entry mechanism 116.

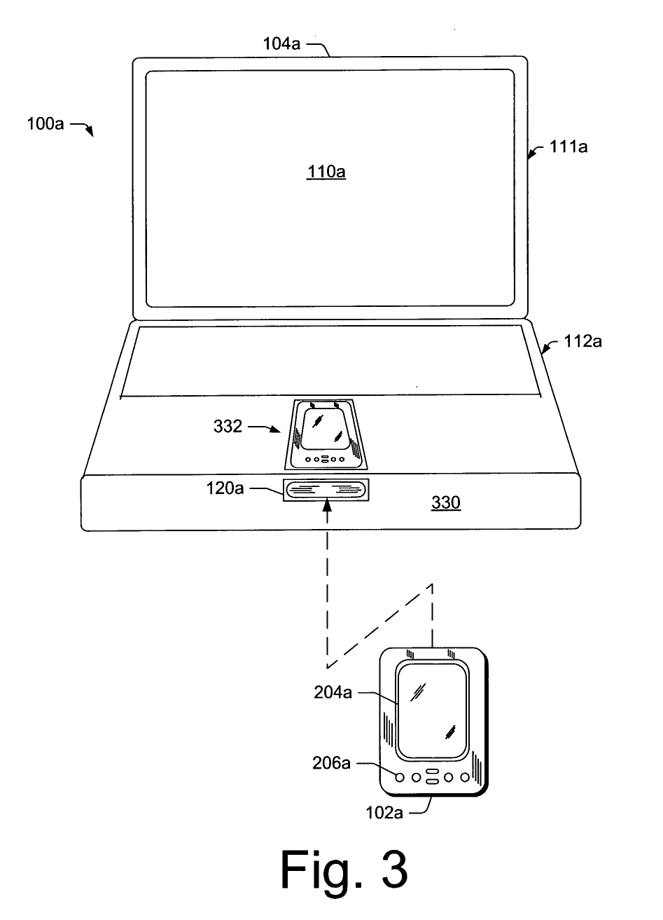

In this embodiment, the computer is configured with a PDA docking port 120 integrated into the palm rest 118 to dock the PDA 102. The PDA docking port 120 may be located in any suitable location on the computer. The docking port is shown on the left-side palm rest for purposes of illustration. The PDA 102 can be selectively docked with, or undocked from, the PDA docking port 120 as represented by the dashed arrow 122. Another exemplary configuration will be described below in relation to FIG. 3.

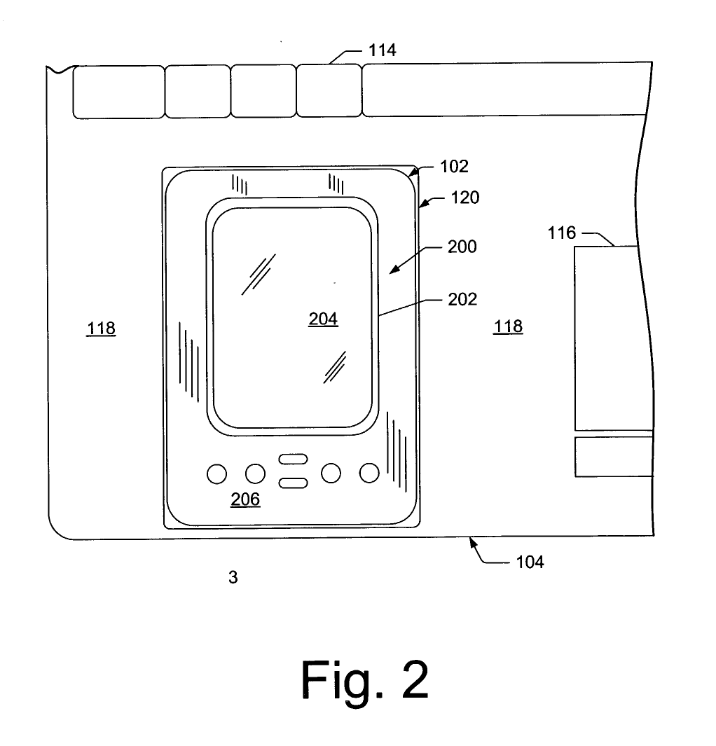

FIG. 2 shows an enlarged view of the PDA 102 when it is docked within the PDA docking port 120. The PDA 102 includes a housing 200 that defines a display area 202. The PDA can have various input mechanisms engagable by a user. As shown here the input mechanisms include a touch-sensitive screen 204 and various user-engagable buttons 206. The user can use either buttons 206 to make various menu selections that are displayed on the touch-sensitive screen 204, or physically contact the touch-sensitive screen directly with a finger or stylus (not shown).

In this embodiment, when the PDA 102 is docked, the PDA can be approximately flush with the palm rest 118, thereby providing a generally continuous surface on which the user of the portable computer 104 can rest his/her palm when operating the keyboard 114 and/or track pad 116. Configurations, such as this one, which provide easy user access to the PDA input mechanisms such as the touch-sensitive screen 204 and/or user-engagable buttons 206 can allow the PDA to provide increased functionality, as will be discussed in more detail below.

The PDA docking port 120 can provide an interface that supports both data communication and power resources. In some embodiments, when docked, the PDA 102 is able to communicate with the portable computer 104, via either direct electrical coupling or other means (e.g., proximity coupling, IR coupling, RF coupling, etc.). The PDA 102 and portable computer 104 can exchange data to synchronize various information, such as appointments, email, contacts, and so on. Additionally, power may be supplied to charge a battery resident at the PDA 102.

Both the PDA 102 and the computer 104 can be operational at the same time. Alternatively, one of the devices may be operational without the other. In this embodiment, the PDA's input mechanisms (e.g., buttons 206, touch-sensitive screen 204, etc.) are exposed when docked to allow the user to enter data while the PDA 102 is mounted in the docking port 120.

Some embodiments can achieve increased system functionality by allowing a user to interact or control the notebook computer by manipulating the input mechanisms of the PDA. FIG. 3 illustrates one such embodiment.

FIG. 3 illustrates another exemplary computing system 100a composed of a PDA 102a and a portable computer 104a. In this embodiment, the portable computer 104a includes a display 110a mounted in a lid 111a that is connected via a hinge to a body 112a.

FIG. 3 shows an exemplary implementation for docking the PDA 102a into a docking port 120a. As shown in this embodiment, the docking port comprises a slot in a front vertical surface 330 of the computer housing. In some embodiments, this slot can comprise a PCMCIA slot, among others. As shown here, the slot can occupy a portion of the housing that in many previous technologies was occupied by a track pad. Such a configuration can position the PDA so that the PDA's input mechanisms are accessible in a horizontally-exposed area 332 of the housing.

The configuration shown here, can allow a user to manipulate buttons 206a and/or a touch-sensitive screen 204a while the PDA is docked. In some embodiments, the touch-sensitive screen can function as a track pad for the computer as well as the traditional function of a touch-sensitive screen on a PDA. This configuration can reduce space constraints and increase functionality. A user can operate the PDA separately from the base computer in a traditional manner. Alternatively, the user can dock the PDA with the computer and continue to use the PDA via the input mechanisms. Further, the user can utilize the PDA's input mechanisms to engage or otherwise control the base computer. In the embodiment shown here, the touch-sensitive screen of the PDA can maintain the familiar look and feel of a track pad in the base computer while eliminating the redundancy of having both a docking port for a PDA and a separate track pad for the computer. This can further reduce space constraints compared to previous designs. This is especially valuable on designs like a portable computer where space is at a premium.

Utilizing a PDA's touch-sensitive screen as a track pad has further advantages. One advantage is that the touch sensitive screen is a display device. As such, various characters or content can be displayed directly on the touch-sensitive screen. This configuration can allow increased user functionality over existing track pads. For example, some embodiments can allow the display of the PDA to be coordinated with the display of the computer. In one configuration, the computer's display can be dedicated to text or graphics and various icons or other user-options can be displayed on the PDA's touch-sensitive screen. In another embodiment, the content of the PDA's display screen can be displayed on both the PDA and the computer display. This can provide larger, more readily discernable text, and still allow the user to make selections on the PDA screen by directly touching the desired icon.

Many suitable configurations can be readily achieved as desired. In some embodiments, a user can select a desired computer system default configuration. For example, a particular user may want the PDA screen display to automatically be displayed on the notebook computer when the PDA is docked to the computer. Another user may want the PDA to default to a second screen display for the notebook computer where the PDA both displays and acts as an input mechanism for the computer. The skilled artisan will recognize other satisfactory configurations.

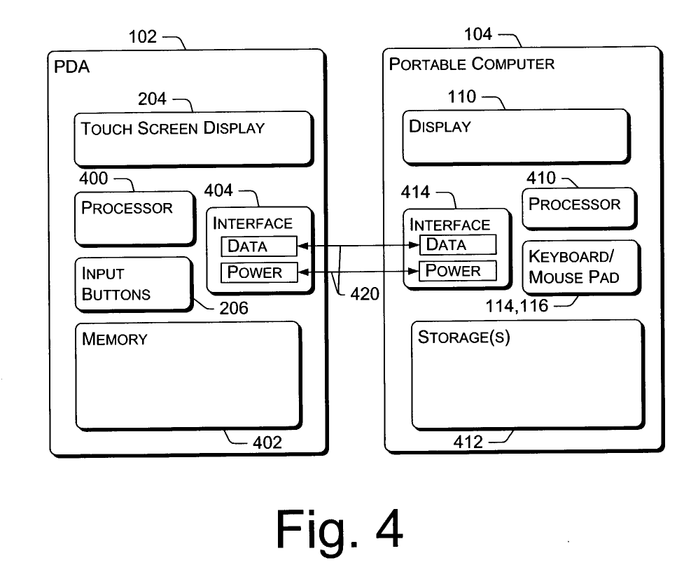

FIG. 4 shows functional components of the PDA 102 and portable computer 104 in accordance with one exemplary embodiment. The PDA 102 includes a processor 400, memory 402 (e.g., RAM, ROM, Flash, etc.), an interface 404, the touch-sensitive screen display 204, and the input buttons 206. The portable computer 104 includes a processor 410, one or more storages 412 (e.g., RAM, ROM, hard disk, floppy disk, CD-ROM, DVD, etc.), an interface 414, the display 110, the keyboard 114, and the track pad 116. The various memory and/or storage devices can comprise computer-readable media upon which computer-readable instructions can be contained.

When the PDA 102 is docked in the docking port, the PDA can communicate with the portable computer via a communication path 420 between the two interfaces 404 and 414. The interfaces 404 and 414 support both data communication and power transfer. In one implementation, the interfaces facilitate serial communication, although the interfaces may be configured to support parallel communication.

The interfaces can allow the commands or signals generated on a portable computing device to control the function of the base computer. For example, the portable computing device's touch sensitive screen can be manipulated by a user to direct a cursor on the base computer. The skilled artisan will recognize other suitable configurations.

Some of the described embodiments also have manufacturing efficiencies of scale as will be recognized by the skilled artisan. For example, the notebook computer shown in FIG. 3 can be built as a basic unit that is configurable to achieve various different suitable configurations according to market demands. For example, a base notebook computer can be formed where the housing can be formed to receive a docking slot. In a base model a traditional track pad can be positioned in the notebook computer in this space. In a higher-end model a docking slot can be functionally positioned in the housing to accept a handheld computing device.

Some docking slots can utilize standardized configurations that can accept various suitably configured devices. For example, a top of the line computing system may include a notebook computer with a docking slot and appropriately configured handheld computing devices, such as a PDA and a cell phone, among others. The handheld computing devices can be docked with the notebook computer as desired by the user. The handheld computing devices can, as described above, have input mechanisms to allow the user to engage the notebook computer. The manufacturing economies can, among other advantages, provide increased customer value over existing designs.

### EXEMPLARY METHODS

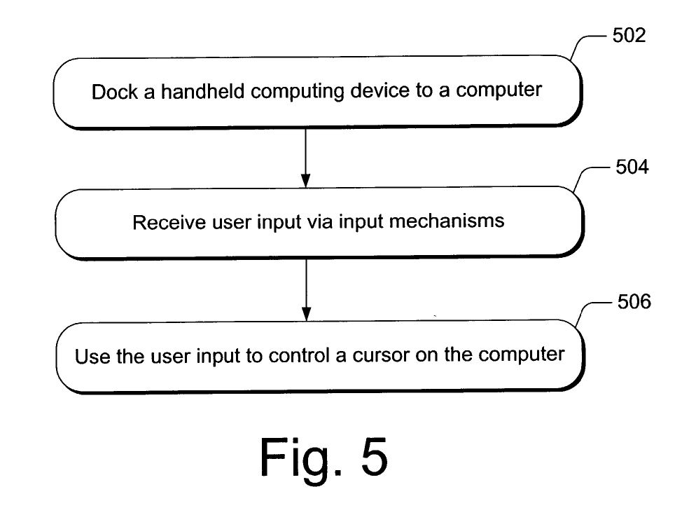

FIG. 5 shows a flow diagram describing an exemplary method in accordance with one embodiment. Step 502 docks a handheld computing device to a computer. One suitable embodiment docks a PDA with the computer. Various techniques for docking have been described above. The skilled artisan will recognize other suitable techniques.

Step 504 receives user input via input mechanisms on the handheld computing device. Various suitable interfaces can allow the computing device to receive the user input. One suitable embodiment provides user input to the computing device via an input mechanism that is electromechanically connected to the computing device. The input can be provided through direct physical engagement of the input mechanism.

Step 506 uses the user input to control a cursor on the computer. One exemplary embodiment comprises controlling the computer utilizing an input mechanism of a PDA. Some embodiments can also display images on the input mechanism when the input mechanism is electromechanically disconnected from the computer.

### CONCLUSION

The computing system described above can comprise a handheld computing device. The handheld computing device can have various input mechanisms such as buttons and a touch-sensitive screen. When docked with the computer, some embodiments can allow a user to engage the notebook computer through manipulation of the handheld computing device's input mechanisms. In one such embodiment, the handheld computing device's touch-sensitive screen can be used as an input mechanism for the handheld computing device and/or as an image displaying track pad for the notebook computer. This configuration can provide increased performance and decreased costs of production over existing technologies.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

What is claimed is:

1. A computing system comprising:
a portable digital assistant (PDA) having a touch-sensitive screen to allow user input; and,
a portable computer configured to dock with the PDA, wherein the computing system is configured to allow user input to the portable computer through manipulation of the touch-sensitive screen when the PDA is docked with the computer.

2. A computing system as recited in claim 1, wherein the PDA is configured to dock in a PCMCIA slot on the portable computer.

3. A computing system as recited in claim 1, wherein the touch-sensitive screen is positioned to function as a track pad for the portable computer.

4. A computing system comprising:
a handheld computing device having one or more input mechanisms to allow user input; and,
a computer configured to dock with the handheld computing device, wherein the computing system is configured to allow user input to the computer through manipulation of the one or more input mechanisms of the handheld computing device when the handheld computing device is docked with the computer.

5. A computing system as recited in claim 4, wherein the one or more input mechanisms comprise a touch-sensitive screen.

6. A computing system as recited in claim 5, wherein the touch-sensitive screen can serve as a track pad for the computer.

7. A computing system as recited in claim 5, wherein the touch-sensitive screen is configured to display an image.

8. A computing system as recited in claim 4, wherein the computer has a display screen, and the system is configured to allow a user to manipulate a cursor on the display screen through manipulation of the one or more input mechanisms of the handheld computing device.

9. A computing system as recited in claim 4, wherein the handheld computing device docks with the computer via a PCMCIA slot.

10. A computing system comprising:
a handheld computing device having at least one user input mechanism for generating signals;
a base computer having a display and the base computer being configured to dock with the handheld computing device; and,
the computing system being configured to allow the signals generated on the at least one user input mechanism to direct a cursor on the base computer.

11. A computing system as recited in claim 10, wherein the handheld computing device comprises a PDA.

12. A computing system as recited in claim 10, wherein the handheld computing device comprises a cell phone.

13. A computing system as recited in claim 12, wherein the cell phone has a touch-sensitive screen.

14. A computing system as recited in claim 10, wherein the base computer comprises a portable computer.

15. A computing system as recited in claim 10, wherein the at least one input mechanism comprises a touch-sensitive screen.

16. A computer, comprising:
a housing;
a processor and memory mounted within the housing; and,
a docking port integrated into the housing to dock a handheld computing device and to interface the handheld computing device with the processor so that a user can engage the computer by manipulation of the handheld computing device.

17. A computer as recited in claim 16, wherein the docking port comprises a PCMCIA slot.

18. A method comprising:
docking a handheld computing device to a computer;
receiving user input via input mechanisms on the handheld computing device; and,
using the user input to control a cursor on the computer.

19. A method as recited in claim 18, wherein said act of docking comprises physically connecting the handheld computing device with the computer.

20. A method as recited in claim 18, wherein said act of receiving comprises receiving user input via a touch-sensitive screen.

21. A method comprising:
docking a PDA with a computer; and,
controlling the computer utilizing an input mechanism of the PDA.

22. A method as recited in claim 21, wherein said act of controlling comprises controlling the computer via a touch-sensitive screen of the PDA.

23. One or more computer-readable media having computer-readable instructions thereon which, when executed by a computer, cause the computer to:
detect when a handheld computing device is docked into a docking port coupled to the computer;
receive input signals generated on an input mechanism of the handheld computing device; and,
control the computer in accordance with the input signals.

24. A computing system comprising:
a keyboard;
a display connected with the keyboard;
an touch-sensitive input screen on the keyboard and configured to receive user input for the computing system; and,
the input screen being removable from the keyboard and when so removed being configured to serve as a display for a different computing device.

25. A computing system as recited in claim 24, wherein the touch sensitive input screen comprises a display screen for a portable computing device.

26. A computing system as recited in claim 24, wherein the touch sensitive input screen comprises a display screen for a PDA.

27. A computing system comprising:
a keyboard;
a display connected with the keyboard;
an input mechanism on the keyboard and configured to receive cursor-controlling user input for the computing system; and,
the input mechanism being removable from the keyboard and being configured to serve as an electronic display.

28. A computing system as recited in claim 27, wherein the input mechanism comprises a touch sensitive screen.

29. A method comprising:
providing user input to a computer via an input mechanism that is electromechanically connected to the computer, the input being provided through direct physical engagement of the input mechanism; and,
displaying images on the input mechanism when the input mechanism is electromechanically disconnected from the computer.

30. A method as recited in claim 29, wherein said act of providing the user input comprises controlling a cursor on the computer via the input mechanism.

31. A computer comprising:
means for docking a handheld computing device to a computer;
means for receiving user input via input mechanisms on the handheld computing device; and,
means for using the user input to control a cursor on the computer.
